(19) United States
(12) Patent Application Publication
(10) Pub. No.: US 2018/0060907 A1
(43) Pub. Date: Mar. 1, 2018

(54) SALES PROMOTION APPARATUS, SALES PROMOTION SYSTEM, STORE SYSTEM, SALES PROMOTION METHOD, AND PROGRAM

(71) Applicant: NEC Corporation, Tokyo (JP)

(72) Inventor: Jun KOBAYASHI, Tokyo (JP)

(73) Assignee: NEC Corporation, Tokyo (JP)

(21) Appl. No.: 15/558,281

(22) PCT Filed: Mar. 2, 2016
(86) PCT No.: PCT/JP2016/056385

§ 371 Date: Sep. 14, 2017

(30) Foreign Application Priority Data
Mar. 20, 2015 (JP) 2015-057770

(51) Int. Cl. G06Q 30/02

(52) U.S. Cl. CPC G06Q 30/0254

(57) ABSTRACT

A sales promotion apparatus includes a first visiting customer information acquisition unit, a different store information presentation unit, a second visiting customer information acquisition unit, and a visiting customer match determination unit. The first visiting customer information acquisition unit acquires, from a first visiting customer information acquisition apparatus provided in the one store, biological information of a customer visiting the one store. The different store information presentation unit outputs, to an output apparatus provided in the one store, information regarding a different store. The second visiting customer information acquisition unit acquires, from a second visiting customer information acquisition apparatus provided in the different store, biological information of a customer visiting the different store. The visiting customer match determination unit determines whether there is a match between the biological information acquired by the first visiting customer information acquisition unit and the information acquired by the second visiting customer information acquisition unit.

### TECHNICAL FIELD

The present invention relates to a sales promotion apparatus, a sales promotion system, a store system, a sales promotion method, and a program.

### BACKGROUND ART

Services in which a common membership card is issued by multiple stores between which points are shared are increasing. Stores participating in such services may sometimes also perform sales promotion activities, aside from points, such as introducing each others' merchandise.

Patent Document 1 describes, as related art, a technology in which a visiting customer is identified by a membership card, and a rebate is thereby paid from a merchandise recommendation destination store to a merchandise recommendation source store.

### PRIOR ART DOCUMENT

### Patent Document

Patent Document 1: PCT International Publication No. WO 2003/038701

### SUMMARY OF THE INVENTION

### Problems to be Solved by the Invention

In order to stimulate economic activity, it was required for various diverse customers to be guided to different stores.

Therefore, the present invention has an exemplary object of providing a sales promotion apparatus, a sales promotion system, a store system, a sales promotion method, and a program that are capable of solving the above-mentioned problem.

### Means for Solving the Problems

In order to achieve the above-mentioned exemplary object, the present invention is directed to a sales promotion apparatus including a first visiting customer information acquisition unit that acquires, from a first visiting customer information acquisition apparatus provided in one store, biological information of a customer visiting the one store; a different store information presentation unit that outputs, to an output apparatus provided in the one store, information regarding a different store other than the one store; a second visiting customer information acquisition unit that acquires, from a second visiting customer information acquisition apparatus provided in the different store, biological information of a customer visiting the different store; and a visiting customer match determination unit that determines whether there is a match between the biological information acquired by the first visiting customer information acquisition unit and the biological information acquired by the second visiting customer information acquisition unit.

Additionally, the present invention is directed to a sales promotion system including the above-mentioned sales promotion apparatus; a visiting customer information acquisition apparatus that acquires biological information; and an output apparatus that outputs information from the sales promotion apparatus, which outputs, to the output apparatus provided in the one store, information regarding the different store other than the one store.

Additionally, the present invention is directed to a store system including a visiting customer information acquisition apparatus that acquires biological information; an output apparatus that outputs information from a sales promotion apparatus, which outputs, to an output apparatus provided in one store, information regarding a different store other than the one store; and a store apparatus that receives information indicating a guidance history from the sales promotion apparatus, which includes a visiting customer information acquisition unit that acquires the biological information transmitted from the visiting customer information acquisition apparatus.

Additionally, the present invention is directed to a store system including a visiting customer information acquisition apparatus that acquires biological information; an output apparatus that outputs information from a sales promotion apparatus, which outputs, to an output apparatus provided in one store, information regarding a different store other than the one store; and a store apparatus that determines whether or not a visiting customer has acquired the information regarding the different store outputted by the output apparatus, and that, upon determining that the visiting customer has acquired the information regarding the different store, outputs biological information of the visiting customer to the sales promotion apparatus, which includes a first visiting customer information acquisition unit that acquires the biological information transmitted from the visiting customer information acquisition apparatus.

Additionally, the present invention is directed to a sales promotion method which includes acquiring, from a first visiting customer information acquisition apparatus provided in one store, biological information of a customer visiting the one store; outputting, to an output apparatus provided in the one store, information regarding a different store other than the one store; acquiring, from a second visiting customer information acquisition apparatus provided in the different store, biological information of a customer visiting the different store; and determining whether there is a match between the biological information of the customer visiting the one store and the biological information of the customer visiting the different store.

Additionally, the present invention is directed to a program that makes a computer function as a first visiting customer information acquisition unit that acquires, from a first visiting customer information acquisition apparatus provided in one store, biological information of a customer visiting the one store; a different store information presentation unit that outputs, to an output apparatus provided in the one store, information regarding a different store other than the one store; a second visiting customer information acquisition unit that acquires, from a second visiting customer information acquisition apparatus provided in the different store, biological information of a customer visiting the different store; and a visiting customer match determination unit that determines whether there is a match between the biological information acquired by the first visiting customer information acquisition unit and the biological information acquired by the second visiting customer information acquisition unit.

### Advantageous Effects of the Invention

Due to the processes performed by the sales promotion apparatus of the present invention, it is possible to guide various diverse visiting customers to different stores.

### BRIEF DESCRIPTION OF DRAWINGS

FIG. 1 is a diagram showing the minimum structure of the sales promotion apparatus of the present invention.

FIG. 2 is a diagram showing the structure of a sales promotion system according to a first exemplary embodiment of the present invention.

FIG. 3 is a first diagram showing a data table according to the present exemplary embodiment.

FIG. 4 is a second diagram showing a data table according to the present exemplary embodiment.

FIG. 5 is a diagram showing the structure of a sales promotion apparatus according to the present exemplary embodiment.

FIG. 6 is a diagram showing the structure of a first store apparatus according to the present exemplary embodiment.

FIG. 7 is a diagram showing the structure of a second store apparatus according to the present exemplary embodiment.

FIG. 8 is a diagram showing the procedural flow in a sales promotion system according to the present exemplary embodiment.

FIG. 9 is a diagram showing the structure of a sales promotion apparatus according to a second exemplary embodiment.

FIG. 10 is a diagram showing the structure of a sales promotion apparatus according to a third exemplary embodiment.

FIG. 11 is a diagram showing the structure of a first store apparatus according to the present exemplary embodiment.

FIG. 12 is a diagram showing the structure of a second store apparatus according to the present exemplary embodiment.

FIG. 13 is a diagram showing the structure of a settlement substitution processing apparatus according to the present exemplary embodiment.

FIG. 14 is a diagram showing the procedural flow of a sales promotion system according to the present exemplary embodiment.

### MODES FOR CARRYING OUT THE INVENTION

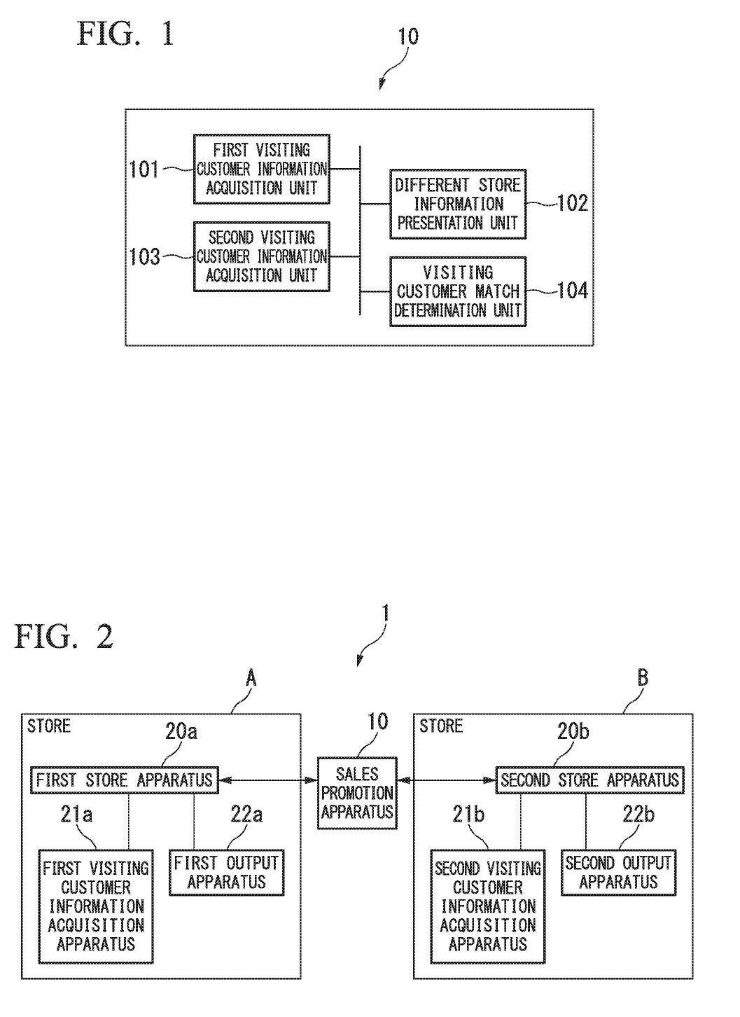

The sales promotion apparatus 10 of the present invention, as shown in FIG. 1, includes at least a first visiting customer information acquisition unit 101, a different store information presentation unit 102, a second visiting customer information acquisition unit 103, and a visiting customer match determination unit 104.

The first visiting customer information acquisition unit 101 acquires, from a first visiting customer information acquisition apparatus provided in one store, biological information of customers visiting the one store.

The different store information presentation unit 102 outputs information relating to a different store, other than the one store, to an output apparatus provided in the one store.

The second visiting customer information acquisition unit 103 acquires, from a second visiting customer information acquisition apparatus provided in the different store, biological information of customers visiting the different store.

The visiting customer match determination unit 104 determines whether or not biological information acquired by the first visiting customer information acquisition unit 101 matches with biological information acquired by the second visiting customer information acquisition unit 103.

### First Exemplary Embodiment

First, a sales promotion system 1 including a sales promotion apparatus 10 according to the first exemplary embodiment of the present invention will be explained. The sales promotion system 1 according to the present embodiment, as shown in FIG. 2, includes a sales promotion apparatus 10, a first store apparatus 20a, a second store apparatus 20b, a first visiting customer information acquisition apparatus 21a, a second visiting customer information acquisition apparatus 21b, a first output apparatus 22a, and a second output apparatus 22b.

It is to be noted that the system in store A, which includes the first store apparatus 20a, the first visiting customer information acquisition apparatus 21a, and the first output apparatus 22a, is referred to as the first store system (store system). Additionally, the system in store B, which includes the second store apparatus 20b, the second visiting customer information acquisition apparatus 21b, and the second output apparatus 22b, is referred to as the second store system (store system).

The sales promotion apparatus 10 includes at least a first visiting customer information acquisition unit 101, a different store information presentation unit 102, a second visiting customer information acquisition unit 103, and a visiting customer match determination unit 104.

The sales promotion apparatus 10 outputs, to the first output apparatus 22a provided in store A, information regarding a store other than store A, for example, information regarding store B. Additionally, the sales promotion apparatus 10 outputs, to the second output apparatus 22b provided in store B, information regarding a store other than store B, for example, information regarding store A.

The first visiting customer information acquisition apparatus 21a acquires biological information of customers visiting store A. The first visiting customer information acquisition apparatus 21a may, for example, be a camera. If the first visiting customer information acquisition apparatus 21a is a camera, then the first visiting customer information acquisition apparatus 21a acquires facial images by capturing facial images of customers visiting store A.

The second visiting customer information acquisition apparatus 21b acquires biological information of customers visiting store B. The second visiting customer information acquisition apparatus 21b may, for example, be a camera. If the second visiting customer information acquisition apparatus 21b is a camera, then the second visiting customer information acquisition apparatus 21b acquires facial images by capturing facial images of customers visiting store B.

The first output apparatus 22a outputs information from the sales promotion apparatus 10, which outputs information regarding a different store other than store A. For example, the first output apparatus 22a may be an apparatus having a display screen, such as digital signage or a smartphone, provided in store A, or a speaker provided in store A. If the first output apparatus 22a is an apparatus having a display screen provided in store A, then the first output apparatus 22a displays store information regarding store B, which the sales promotion apparatus 10 has transmitted to the first output apparatus 22a. Additionally, if the first output apparatus 22a is a speaker provided in store A, then the first output apparatus 22a outputs, in a synthesized voice, store information regarding store B, which the sales promotion apparatus 10 has transmitted to the first output apparatus 22a.

The second output apparatus 22b outputs information from the sales promotion apparatus 10, which outputs information regarding a different store other than store B. For example, the second output apparatus 22b may be an apparatus having a display screen, such as digital signage or a smartphone, provided in store B, or a speaker provided in store B. If the second output apparatus 22b is an apparatus having a display screen provided in store B, then the second output apparatus 22b displays store information regarding store A, which the sales promotion apparatus 10 has transmitted to the second output apparatus 22b. Additionally, for example, if the second output apparatus 22b is a speaker provided in store B, then the second output apparatus 22b outputs, in a synthesized voice, store information regarding store A, which the sales promotion apparatus 10 has transmitted to the second output apparatus 22b.

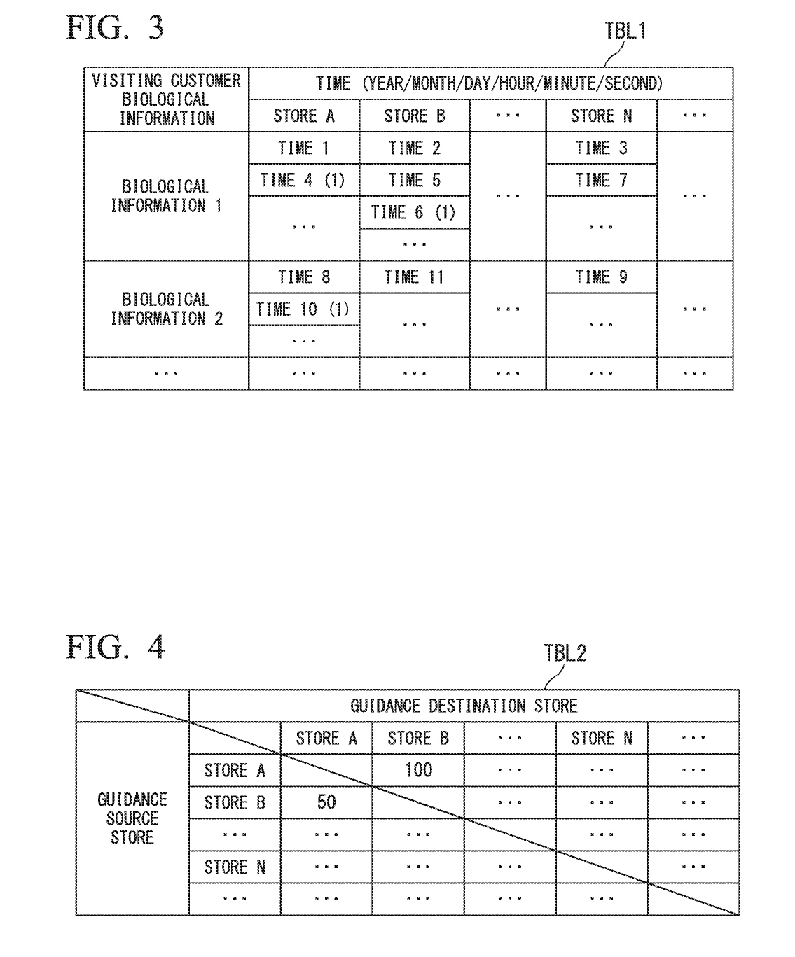

The sales promotion apparatus 10 acquires biological information of customers visiting store A from the first visiting customer information acquisition apparatus 21a. Additionally, the sales promotion apparatus 10 acquires biological information of customers visiting store B from the second visiting customer information acquisition apparatus 21b. The sales promotion apparatus 10 records the acquired biological information of the visiting customers in a memory unit. For example, the sales promotion apparatus 10 generates a data table TBL1 such as that shown in FIG. 3, by associating biological information of customers visiting store A, acquired from the first visiting customer information acquisition apparatus 21a, with the times of acquisition, from the first visiting customer information acquisition apparatus 21a, of the biological information of the customers visiting store A, and associating biological information of customers visiting store B, acquired from the second visiting customer information acquisition apparatus 21b, with the times of acquisition, from the second visiting customer information acquisition apparatus 21b of the biological information of the customers visiting store B. The sales promotion apparatus 10 records the generated data table TBL1 in the memory unit.

Additionally, the sales promotion apparatus 10 determines whether or not there is a match between the acquired biological info′ nation of the customers visiting store A and the acquired biological information of the customers visiting store B. When it is determined that there is a match between the biological information of a customer visiting store A, acquired from the first store apparatus 20a, and the biological information of a customer visiting store B, acquired from the second store apparatus 20b, the sales promotion apparatus 10 generates information indicating the guidance history between store A and store B. Specifically, for example, the sales promotion apparatus 10 generates a data table TBL2 such as that shown in FIG. 4, indicating the number of times that a visiting customer who has visited the guidance source store has been guided to the guidance destination store, on the basis of the movement, between stores, of visiting customers indicated by data table TBL1.

The sales promotion apparatus 10 generates payment information from the different store to the one store on the basis of generated information indicating the guidance history from the one store to the different store. For example, the sales promotion apparatus 10 generates payment information corresponding to the difference between the guidance history of visiting customers from store A to store B and the guidance history of visiting customers from store B to store A in the generated data table TBL2. Specifically, for example, if the guidance history for visiting customers from store A to store B includes 100 events and the guidance history for visiting customers from store B to store A includes 50 events as in the data table TBL2 shown in FIG. 4, then the sales promotion apparatus 10 generates information for payment of a fee corresponding to the difference of 50 events from store B to store A.

In the sales promotion system 1 according to an exemplary embodiment of the present invention, each of a plurality of registered stores belonging to different enterprises (e.g., individually operated stores or the like) provides, to customers who are visiting a given store, information relating to different stores aside from the given store, thereby guiding various diverse visiting customers to different stores and stimulating economic activity. It is to be noted that at this time, there is no need for the visiting customers to register membership.

Next, the structure of the sales promotion apparatus 10 according to the present exemplary embodiment will be explained.

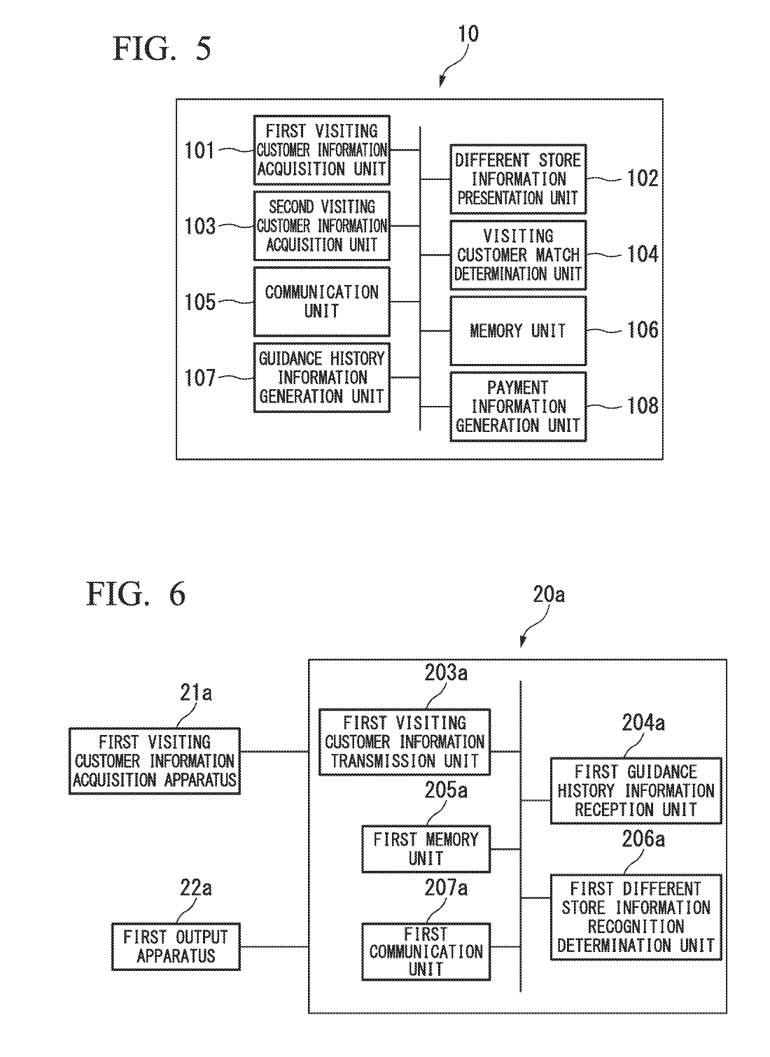

The sales promotion apparatus 10 according to the present exemplary embodiment includes at least the first visiting customer information acquisition unit 101, the different store information presentation unit 102, the second visiting customer information acquisition unit 103, and the visiting customer match determination unit 104, which are shown in FIG. 1, and further includes a communication unit 105, a memory unit 106, a guidance history information generation unit 107 and a payment information generation unit 108, as shown in FIG. 5.

The first visiting customer information acquisition unit 101 acquires biological information of customers visiting one store, from a first visiting customer information acquisition apparatus 21a provided in the one store. For example, the first visiting customer information acquisition unit 101 acquires biological information of customers visiting store A from a first visiting customer information acquisition apparatus 21a provided in store A. The first visiting customer information acquisition unit 101 generates a data table TBL1 in which the acquired biological information of the visiting customers is associated with the times at which the first visiting customer information acquisition apparatus 21a acquired the biological information of the visiting customers, and records the generated data table TBL1 in the memory unit 106.

The different store information presentation unit 102 outputs, to an output apparatus provided in the one store, information regarding a different store other than the one store. For example, the different store information presentation unit 102 outputs store information regarding store B to a first output apparatus 22a provided in store A.

The second visiting customer information acquisition unit 103 acquires biological information of customers visiting the different store, from a second visiting customer information acquisition apparatus 21b provided in the different store. For example, the second visiting customer information acquisition unit 103 acquires biological information of customers visiting store B, from a second visiting customer information acquisition apparatus 21b provided in store B. The second visiting customer information acquisition unit 103 associates the acquired biological information of the visiting customers with the times at which the second visiting customer information acquisition apparatus 21b acquired the biological information of the visiting customers, and records the information in a data table TBL1 in the memory unit 106.

The visiting customer match determination unit 104 determines whether or not there is a match between the biological information acquired by the first visiting customer information acquisition unit 101 and the biological information acquired by the second visiting customer information acquisition unit 103. For example, the visiting customer match determination unit 104 determines whether or not there is a match between the biological information of the customers visiting store A acquired by the first visiting customer information acquisition unit 101 and the biological information of the customers visiting store B acquired by the second visiting customer information acquisition unit 103.

The communication unit 105 communicates with the first store apparatus 20a and the second store apparatus 20b via a communication channel such as a LAN (Local Area Network). It is to be noted that the communication channel may be wired or wireless.

The memory unit 106 stores information necessary for the sales promotion apparatus 10 to carry out various processes. Additionally, the memory unit 106 stores information regarding stores other than store A, which the sales promotion apparatus 10 transmits to the first store apparatus 20a provided in store A. For example, the memory unit 106 stores store information regarding store B, transmitted to the first store apparatus 20a by the sales promotion apparatus 10.

The guidance history information generation unit 107 generates information indicating the guidance history from one store to a different store when the visiting customer match determination unit 104 determines that there is a match between the biological information acquired by the first visiting customer information acquisition unit 101 and the biological information acquired by the second visiting customer information acquisition unit 103. For example, if the visiting customer match determination unit 104 determines that there is a match between biological information for a customer visiting store A acquired by the first visiting customer information acquisition unit 101 and the biological information for a customer visiting store B acquired by the second visiting customer information acquisition unit 103, then the guidance history information generation unit 107 generates information indicating the guidance history of visiting customers between store A and store B. Specifically, for example, the guidance history information generation unit 107 generates the data table TBL2 shown in FIG. 4, which indicates the number of times a visiting customer who has visited a guidance source store has been guided to a guidance destination store, based on the movement of visiting customers between stores indicated by data table TBL1.

The payment information generation unit 108 generates payment information from the different store to the one store on the basis of information indicating the guidance history from the one store to the different store generated by the guidance history information generation unit 107. For example, the payment information generation unit 108 generates payment information in accordance with the difference between the guidance history of visiting customers from store A to store B and the guidance history of visiting customers from store B to store A in the data table TBL2 generated by the guidance history information generation unit 107. Specifically, for example, when the guidance history of visiting customers from store A to store B includes 100 events and the guidance history of visiting customers from store B to store A includes 50 events in the data table TBL2 shown in FIG. 4, then the payment information generation unit 108 generates information for paying a fee corresponding to the difference of 50 events from store B to store A.

Next, the structure of the first store apparatus 20a provided in store A according to the present exemplary embodiment will be explained.

The first store apparatus 20a according to the present exemplary embodiment includes a first visiting customer information transmission unit 203a, a first guidance history information reception unit 204a, a first memory unit 205a, a first different store information recognition determination unit 206a, and a first communication unit 207a, as shown in FIG. 6.

The first visiting customer information transmission unit 203a transmits, to a store other than store A, biological information of a customer visiting store A, acquired by the first visiting customer information acquisition apparatus 21a.

The first guidance history information reception unit 204a receives, from the sales promotion apparatus 10, information indicating the guidance history from the one store to different stores.

The first memory unit 205a stores various types of information that are necessary for the processing to be performed by the first store apparatus 20a.

The first different store information recognition determination unit 206a determines whether or not a customer visiting store A has recognized the different store information outputted by the first output apparatus 22a.

For example, the first different store information recognition determination unit 206a may detect the line of sight of a visiting customer which is captured by a camera installed on the first output apparatus 22a, and on the basis of the detected line of sight, determine whether or not the visiting customer has seen the first output apparatus 22a, in other words, whether or not the different store information has been recognized. In this case, the first different store information recognition determination unit 206a determines that the visiting customer has recognized the different store information if, for example, the detected line of sight of the visiting customer is directed towards the first output apparatus 22a. Additionally, the first different store information recognition determination unit 206a may determine that the visiting customer has not recognized the different store information if, for example, the detected line of sight of the visiting customer was never directed towards the first output apparatus 22a.

Additionally, for example, the first different store information recognition determination unit 206a may determine whether or not the visiting customer has recognized the different store information on the basis of the duration of the customer's visit. In this case, the first different store information recognition determination unit 206a determines that the visiting customer has recognized the different store information if the duration of the customer's visit is equal to or greater than a predetermined period of time. Additionally, the first different store information recognition determination unit 206a may determine that the visiting customer has not recognized the different store information if the duration of the customer's visit is less than a predetermined period of time.

Additionally, for example, the first different store information recognition determination unit 206a may determine whether or not a visiting customer has recognized the different store information on the basis of the time at which the first visiting customer information acquisition apparatus 21a acquired the biological information of the visiting customer and the time at which the first output apparatus 22a outputted the different store information. In this case, for example, the first different store information recognition determination unit 206a determines that the visiting customer has recognized different store information that was outputted by the first output apparatus 22a within a predetermined period of time after the time of acquisition of the biological information of the visiting customer by the first visiting customer information acquisition apparatus 21a. Additionally, the first different store information recognition determination unit 206a determines that the visiting customer has not recognized different store information that was outputted by the first output apparatus 22a more than a predetermined period of time after the time of acquisition of the biological information of the visiting customer by the first visiting customer information acquisition apparatus 21a.

Additionally, for example, the first different store information recognition determination unit 206a may determine whether or not a visiting customer has recognized the different store information based on whether or not the visiting customer has performed a predetermined operation on the first output apparatus 22a. In this case, the first different store information recognition determination unit 206a determines that the visiting customer has recognized the different store information upon detecting an operation such as, for example, an operation by the visiting customer providing instructions to issue a coupon associated with the different store information outputted by the first output apparatus 22a, an operation by the visiting customer providing instructions to output detailed information associated with the different store information outputted by the first output apparatus 22a, or an operation by the visiting customer providing instructions to switch the different store information outputted by the first output apparatus 22a. Additionally, the first different store information recognition determination unit 206a may determine that the visiting customer has not recognized the different store information if, for example, an operation by the visiting customer with respect to the first output apparatus 22a is not detected.

The first communication unit 207a communicates with the sales promotion apparatus 10 and the second store apparatus 20b via a communication channel such as a LAN (Local Area Network). It is to be noted that the communication channel may be wired or wireless.

Next, the structure of the second store apparatus 20b provided in store B according to the present exemplary embodiment will be explained.

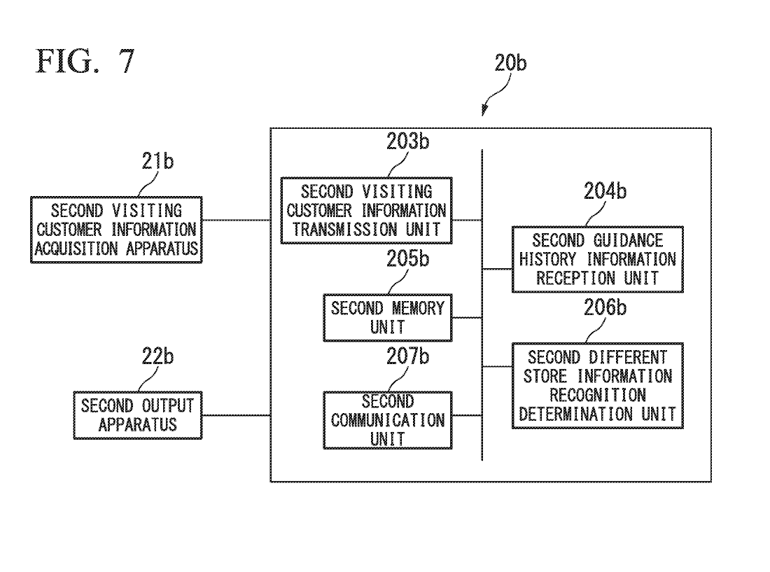

The second store apparatus 20b according to the present exemplary embodiment includes a second visiting customer information transmission unit 203b, a second guidance history information reception unit 204b, a second memory unit 205b, a second different store information recognition determination unit 206b, and a second communication unit 207b, as shown in FIG. 7.

The second visiting customer information transmission unit 203b transmits, to a store other than store B, biological information of a customer visiting store B, acquired by the second visiting customer information acquisition apparatus 21b.

The second guidance history information reception unit 204b receives, from the sales promotion apparatus 10, information indicating the guidance history from the one store to different stores.

The second memory unit 205b stores various types of information that are necessary for the processing to be performed by the second store apparatus 20b.

The second different store information recognition determination unit 206b determines whether or not a customer visiting store B has recognized the different store information outputted by the second output apparatus 22b.

For example, the second different store information recognition determination unit 206b may detect the line of sight of a visiting customer which is captured by a camera installed on the second output apparatus 22b, and on the basis of the detected line of sight, determine whether or not the visiting customer has seen the second output apparatus 22b, in other words, whether or not the different store information has been recognized. In this case, the second different store information recognition determination unit 206b determines that the visiting customer has recognized the different store information if the detected line of sight of the visiting customer is directed towards the second output apparatus 22b. Additionally, the second different store information recognition determination unit 206b may determine that the visiting customer has not recognized the different store information if the detected line of sight of the visiting customer was never directed towards the second output apparatus 22b.

Additionally, for example, the second different store information recognition determination unit 206b may determine whether or not the visiting customer has recognized the different store information based on the duration of the customer's visit. In this case, the second different store information recognition determination unit 206b determines that the visiting customer has recognized the different store information if the duration of the customer's visit is equal to or greater than a predetermined period of time. Additionally, the second different store information recognition determination unit 206b may determine that the visiting customer has not recognized the different store information if the duration of the customer's visit is less than a predetermined period of time.

Additionally, for example, the second different store information recognition determination unit 206b may determine whether or not a visiting customer has recognized the different store information based on the time at which the second visiting customer information acquisition apparatus 21b acquired the biological information of the visiting customer and the time at which the second output apparatus 22b outputted the different store information. In this case, the second different store information recognition determination unit 206b determines that the visiting customer has recognized different store information that was outputted by the second output apparatus 22b within a predetermined period of time after the time of acquisition of the biological information of the visiting customer by the second visiting customer information acquisition apparatus 21b. Additionally, the second different store information recognition determination unit 206b may determine that the visiting customer has not recognized different store information that was outputted by the second output apparatus 22b more than a predetermined period of time after the time of acquisition of the biological information of the visiting customer by the second visiting customer information acquisition apparatus 21b.

Additionally, for example, the second different store information recognition determination unit 206b may determine whether or not a visiting customer has recognized the different store information based on whether or not the visiting customer has performed a predetermined operation on the second output apparatus 22b. In this case, the second different store information recognition determination unit 206b determines that the visiting customer has recognized the different store information upon detecting an operation such as, for example, an operation by the visiting customer providing instructions to issue a coupon associated with the different store information outputted by the second output apparatus 22b, an operation by the visiting customer providing instructions to output detailed information associated with the different store information outputted by the second output apparatus 22b, or an operation by the visiting customer providing instructions to switch the different store information outputted by the second output apparatus 22b. Additionally, the second different store information recognition determination unit 206b may determine that the visiting customer has not recognized the different store information if, for example, an operation by the visiting customer with respect to the second output apparatus 22b is not detected.

The second communication unit 207b communicates with the sales promotion apparatus 10 and the first store apparatus 20a via a communication channel such as a LAN (Local Area Network). The communication channel may be wired or wireless.

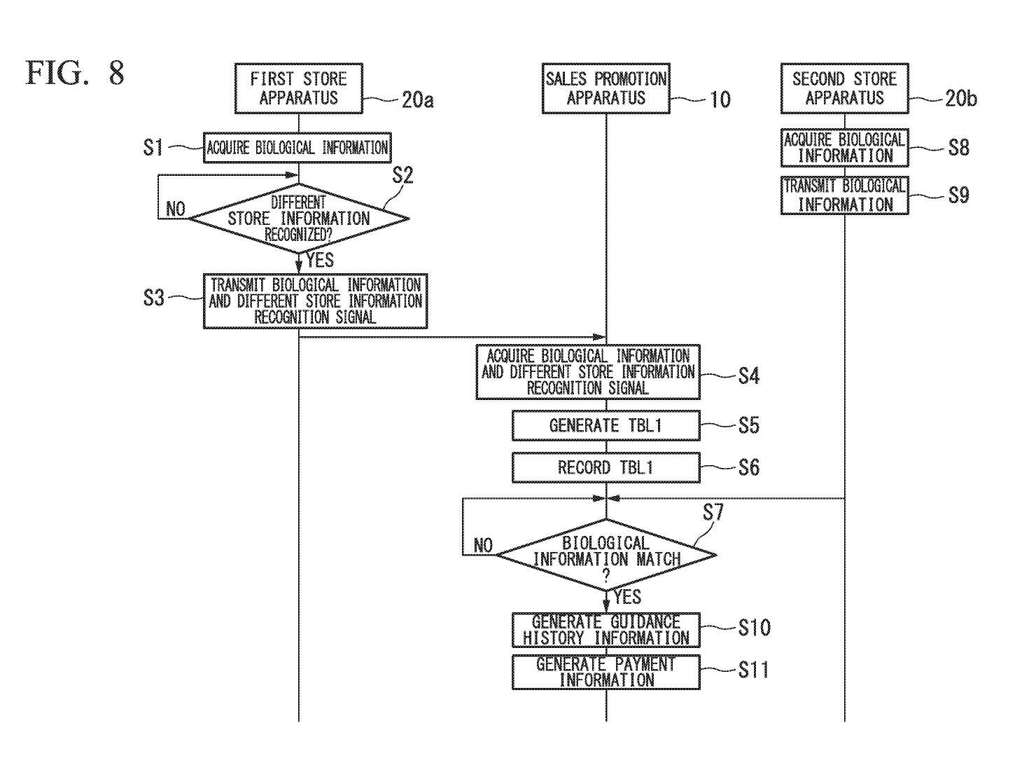

Next, the procedural flow of the sales promotion system 1 according to the present exemplary embodiment shown in FIG. 8 will be explained.

It is to be noted that it is assumed that store A and store B have already been registered in the sales promotion system 1, the first store apparatus 20a provided in store A outputs store information regarding store B, and the second store apparatus 20b provided in store B outputs store information regarding store A. The procedure that is implemented by the sales promotion system 1 when a customer visiting store A acquires store information regarding store B outputted by the output apparatus installed in store A, and subsequently goes to store B and purchases merchandise, will be explained.

The first output apparatus 22a provided in store A outputs store information regarding store B. The customer arrives at store A.

The first visiting customer information acquisition apparatus 21a acquires biological information of the visiting customer (step S1). For example, the first visiting customer information acquisition apparatus 21a may be a camera, which captures a facial image of the visiting customer and acquires the facial image as biological information.

The first different store information recognition determination unit 206a determines whether or not the customer visiting store A has recognized the different store information outputted by the first output apparatus 22a (step S2).

If the first different store information recognition determination unit 206a determines that the different store information outputted by the first output apparatus 22a has not been recognized by the customer visiting store A (step S2, NO), then the procedure returns to step S2.

Additionally, if the first different store information recognition determination unit 206a determines that the different store information outputted by the first output apparatus 22a has been recognized by the customer visiting store A (step S2, YES), then the first visiting customer information acquisition apparatus 21a outputs a different store information recognition signal indicating that the visiting customer has recognized the different store information, together with the acquired biological information of the visiting customer, to the first visiting customer information transmission unit 203a.

Upon acquiring the biological information of the visiting customer and the different store information recognition signal from the first visiting customer information acquisition apparatus 21a, the first visiting customer information transmission unit 203a transmits the acquired biological information of the visiting customer and the different store information recognition signal to the sales promotion apparatus 10 (step S3).

Upon acquiring the biological information of the customer visiting store A and the different store information recognition signal from the first visiting customer information acquisition apparatus 21a provided in store A (step S4), the first visiting customer information acquisition unit 101 generates a data table TBL1 by associating the acquired biological information of the customer visiting store A, the time at which the first visiting customer information acquisition apparatus 21a acquired the biological information of the visiting customer, and a different store information recognition flag indicating that the visiting customer has recognized the different store information (step S5). It is to be noted that in the case of the data table TBL1 shown in FIG. 3, the data indicated by a “1” in parentheses together with a time is the different store information recognition flag. The first visiting customer information acquisition unit 101 records the generated data table TBL1 in the memory unit 106 (step S6).

The first visiting customer information acquisition unit 101 outputs the acquired biological information of the customer visiting store A to the visiting customer match determination unit 104.

Upon acquiring the biological information of the customer visiting store A from the first visiting customer information acquisition unit 101, the visiting customer match determination unit 104 determines whether or not there is a match between the acquired biological information of the customer visiting store A and biological information acquired by the second visiting customer information acquisition unit 103 (step S7). For example, the visiting customer match determination unit 104 determines whether or not there is a match between the acquired biological information of the customer visiting store A and biological information of a customer visiting store B acquired by the second visiting customer information acquisition unit 103 in the data table TBL1.

Upon determining that there is a match between the acquired biological information of the customer visiting store A and biological information acquired by the second visiting customer information acquisition unit 103 (step S7, YES), the visiting customer match determination unit 104 outputs, to the guidance history information generation unit 107, a biological information match signal indicating that there is a match in the biological information.

Additionally, upon determining that there is no match between the acquired biological information of the customer visiting store A and the biological information acquired by the second visiting customer information acquisition unit 103 (step S7, NO), the visiting customer match determination unit 104 returns the procedure to step S7.

In the case of the example of the procedural flow according to the present exemplary embodiment, the second visiting customer information acquisition unit 103 has not yet acquired biological information, so the visiting customer match determination unit 104 determines that there is no match between the acquired biological information of the customer visiting store A and the biological information acquired by the second visiting customer information acquisition unit 103 (step S7, NO), and the procedure returns to step S7.

Suppose that the customer who visited store A decides to visit store B after recognizing the different store information outputted by the first output apparatus 22a in store A.

The second visiting customer information acquisition apparatus 21b acquires biological information of the visiting customer (step S8). For example, the second visiting customer information acquisition apparatus 21b may be a camera, which captures a facial image of the visiting customer and acquires the facial image as biological information.

The second visiting customer information acquisition apparatus 21b outputs the acquired biological information of the visiting customer to the second visiting customer information transmission unit 203b.

Upon acquiring the biological information of the visiting customer from the second visiting customer information acquisition apparatus 21b, the second visiting customer information transmission unit 203b transmits the acquired biological information of the customer visiting store B to the sales promotion apparatus 10 (step S9).

When the second visiting customer information acquisition unit 103 acquires the biological information of the customer visiting store B from the second store apparatus 20b, the visiting customer match determination unit 104, which has performed the procedure of step S7, determines whether or not there is a match between the acquired biological information of the customers visiting store A and the biological information that the second visiting customer information acquisition unit 103 acquired from the second store apparatus 20b.

In the case of the example of the procedural flow according to the present exemplary embodiment, the visiting customer match determination unit 104 determines that there is a match between the acquired biological information of a customer visiting store A and the biological information acquired by the second visiting customer information acquisition unit 103 (step S7, YES), and outputs, to the guidance history information generation unit 107, a biological information match signal indicating that there is a match in the biological information.

When the biological information match signal is inputted from the visiting customer match determination unit 104, the guidance history information generation unit 107 generates guidance history information indicating a guidance event from the one store to the different store, based on movement from the store in which the visiting customer was present at a time associated with a different store information recognition flag, indicated by the data table TBL1, to the different store in which the visiting customer was present at a subsequent time (step S10). For example, in the case of the data table TBL1 shown in FIG. 3, the guidance history information generation unit 107 determines that the visiting customer having the biological information 1, who was present at store A between time 4 and time 5, has been guided from store A to store B. As shown in FIG. 4, the guidance history information generation unit 107 generates a data table TBL2 showing the number of guidance events in which a customer visiting a guidance source store has been guided to a guidance destination store. Additionally, the guidance history information generation unit 107 increments, by one, the number of guidance events in data table TBL2 wherein the guidance source store is store A and the guidance destination store is store B.

The guidance history information generation unit 107 outputs, to the payment information generation unit 108, a payment information generation signal providing instructions to generate payment information.

Upon acquiring the payment information generation signal from the guidance history information generation unit 107, the payment information generation unit 108 generates payment information from the different store to the one store based on information indicating the guidance history from the one store to the different store generated by the guidance history information generation unit 107 (step S11). For example, the payment information generation unit 108 generates payment information in accordance with the difference between the guidance history of visiting customers from store A to store B and the guidance history of visiting customers from store B to store A in the data table TBL2 generated by the guidance history information generation unit 107. Specifically, for example, when the guidance history of visiting customers from store A to store B includes 100 events and the guidance history of visiting customers from store B to store A includes 50 events in the data table TBL2 shown in FIG. 4, then the payment information generation unit 108 generates payment information for paying a fee corresponding to the difference of 50 events from store B to store A.

The sales promotion system 1 according to the first exemplary embodiment of the present invention has been explained above. In the above-described sales promotion apparatus 10, the first visiting customer information acquisition unit 101 acquires the biological information of customers visiting the one store from a first visiting customer information acquisition apparatus 21a provided in the one store. The different store information presentation unit 102 outputs information regarding a different store other than the one store to the first output apparatus 22a (output apparatus) provided in the one store. The second visiting customer information acquisition unit 103 acquires biological information of customers visiting the different store from second visiting customer information acquisition apparatus 21b provided in the different store. The visiting customer match determination unit 104 determines whether or not there is a match between the biological information acquired by the first visiting customer information acquisition unit 101 and the second visiting customer information acquisition unit 103.

By doing so, it is possible to guide various diverse visiting customers to different stores. Additionally, various diverse visiting customers can be guided to different stores without the need to register membership. As a result, economic activity can be stimulated.

### Second Exemplary Embodiment

Next, a sales promotion system 1 including a sales promotion apparatus 10 according to a second exemplary embodiment of the present invention will be explained.

The sales promotion system 1 according to the present exemplary embodiment, like the sales promotion system 1 according to the first exemplary embodiment, includes a sales promotion apparatus 10, a first store apparatus 20a, a second store apparatus 20b, a first visiting customer information acquisition apparatus 21a, a second visiting customer information acquisition apparatus 21b, a first output apparatus 22a, and a second output apparatus 22b.

It is to be noted that the difference between the sales promotion system 1 according to the present exemplary embodiment and the sales promotion system 1 according to the first exemplary embodiment lies in the sales promotion apparatus 10.

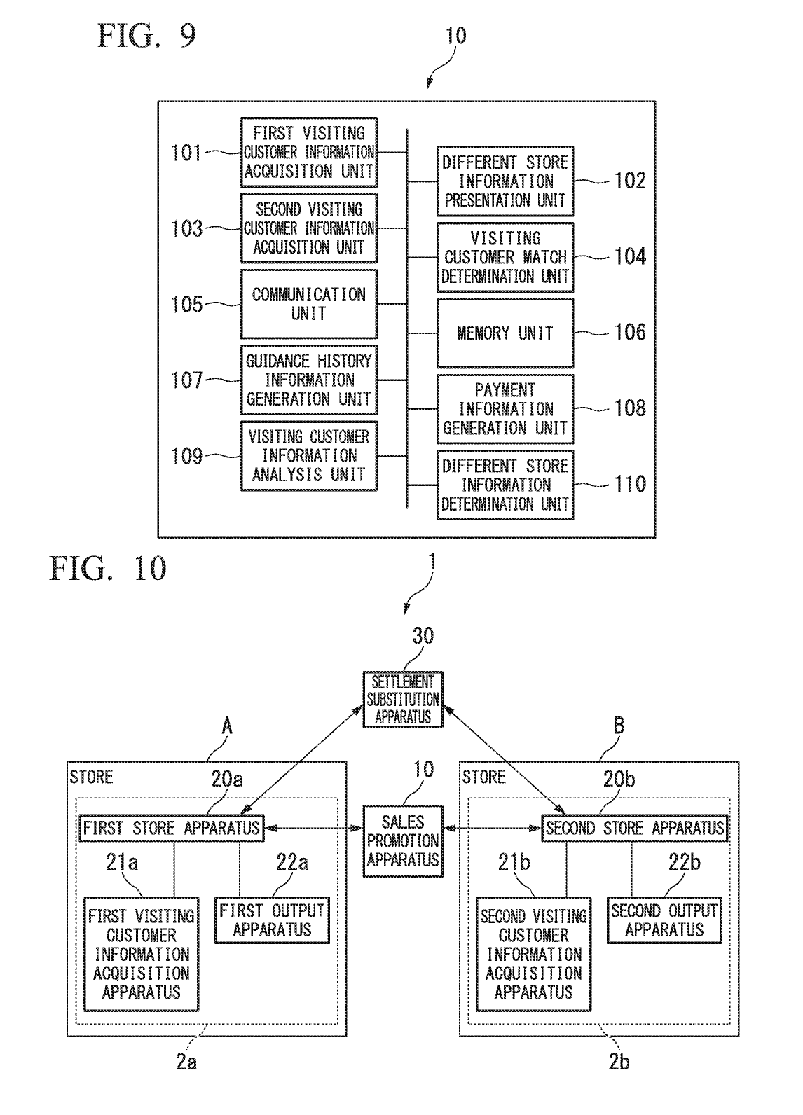

The sales promotion apparatus 10 according to the present exemplary embodiment, as shown in FIG. 9, includes a first visiting customer information acquisition unit 101, a different store information presentation unit 102, a second visiting customer information acquisition unit 103, a visiting customer match determination unit 104, a communication unit 105, a memory unit 106, a guidance history information generation unit 107, and a payment information generation unit 108, as in the sales promotion apparatus 10 according to the first exemplary embodiment, and in addition thereto, further includes a visiting customer information analysis unit 109 and a different store information determination unit 110.

The visiting customer information analysis unit 109 analyzes the biological information of customers visiting the one store acquired by the first visiting customer information acquisition unit 101. For example, the visiting customer information analysis unit 109 analyzes the gender, age and the like of the customers visiting store A based on biological information for the customers visiting store A acquired by the first visiting customer information acquisition unit 101. The visiting customer information analysis unit 109 outputs the analyzed gender, age and the like of the customers visiting store A to the different store information determination unit 110.

Additionally, the visiting customer information analysis unit 109 similarly analyzes the biological information of customers visiting the one store acquired by the second visiting customer information acquisition unit 103. For example, the visiting customer information analysis unit 109 analyzes the gender, age and the like of the customers visiting store B based on biological information for the customers visiting store B acquired by the second visiting customer information acquisition unit 103. The visiting customer information analysis unit 109 outputs the analyzed gender, age and the like of the customers visiting store B to the different store information determination unit 110.

The different store information determination unit 110 acquires the gender, age and the like of the customers visiting store A analyzed by the visiting customer information analysis unit 109. The different store information determination unit 110 determines the different store information to be transmitted to the output apparatus provided in a different store other than store A, based on the acquired gender, age and the like of the customers visiting store A. For example, the different store information determination unit 110 determines, as the different store information to be transmitted to an output apparatus provided in a different store other than store A, different store information relating to merchandise of tastes that are in accordance with the acquired gender, age and the like of the customers visiting store A. The different store information determination unit 110 outputs the determined different store information to the different store information presentation unit 102.

Additionally, the different store information determination unit 110 acquires the gender, age and the like of the customers visiting store B analyzed by the visiting customer information analysis unit 109. The different store information determination unit 110 determines the different store information to be transmitted to the output apparatus provided in a different store other than store B, based on the acquired gender, age and the like of the customers visiting store B. For example, the different store information determination unit 110 determines, as the different store information to be transmitted to an output apparatus provided in a different store other than store B, different store information relating to merchandise of tastes that are in accordance with the acquired gender, age and the like of the customers visiting store B. The different store information determination unit 110 outputs the determined different store information to the different store information presentation unit 102.

The different store information presentation unit 102 transmits, to the output apparatus provided in a different store other than store A, different store information relating to merchandise of tastes that are in accordance with the acquired gender, age and the like of the customers visiting store A determined by the different store information determination unit 110. Additionally, the different store information presentation unit 102 transmits, to the output apparatus provided in a different store other than store B, different store information relating to merchandise of tastes that are in accordance with the acquired gender, age and the like of the customers visiting store B determined by the different store information determination unit 110.

The first output apparatus 22a provided in store A outputs the different store information relating to merchandise of tastes that are in accordance with the gender, age and the like of the customers visiting store B. Additionally, the second output apparatus 22b provided in store B outputs the different store information relating to merchandise of tastes that are in accordance with the gender, age and the like of the customers visiting store A.

It is to be noted that the procedural flow of the sales promotion system 1 according to the present exemplary embodiment is the same as the procedural flow of the sales promotion system 1 according to the first exemplary embodiment shown in FIG. 8.

The sales promotion system 1 according to the second exemplary embodiment of the present invention has been explained above. In the above-described sales promotion apparatus 10, the first visiting customer information acquisition unit 101 acquires biological information of customers visiting the one store from a first visiting customer information acquisition apparatus 21a provided in the one store. The different store information presentation unit 102 outputs information regarding a different store other than the one store to the first output apparatus 22a (output apparatus) provided in the one store. The second visiting customer information acquisition unit 103 acquires biological information of customers visiting the different store from the second visiting customer information acquisition apparatus 21b provided in the different store. The visiting customer match determination unit 104 determines whether or not there is a match between the biological information acquired by the first visiting customer information acquisition unit 101 and the biological information acquired by the second visiting customer information acquisition unit 103.

By doing so, it is possible to guide various diverse visiting customers to different stores. Additionally, various diverse visiting customers can be guided to different stores without the need to register membership. As a result, economic activity can be stimulated.

Additionally, the visiting customer information analysis unit 109 analyzes biological information of customers visiting the one store acquired by the first visiting customer information acquisition unit 101. Additionally, the visiting customer information analysis unit 109 similarly analyzes the biological information of customers visiting the one store acquired by the second visiting customer information acquisition unit 103. The different store information determination unit 110 acquires the analyzed gender, age and the like of the customers visiting store A from the visiting customer information analysis unit 109. The different store information determination unit 110 determines different store information to be transmitted to the output apparatus provided in a different store other than store A on the basis of the acquired gender, age or the like of customers visiting store A. Additionally, the different store information determination unit 110 acquires the analyzed gender, age and the like of customers visiting store B from the visiting customer information analysis unit 109. The different store information determination unit 110 determines different store information to be transmitted to the output apparatus provided in a different store other than store B on the basis of the acquired gender, age or the like of the customers visiting store B. The different store information presentation unit 102 transmits, to the output apparatus provided in the different store other than store A, different store information relating to merchandise of tastes in accordance with the gender, age and the like of the customers visiting store A, determined by the different store information determination unit 110. Additionally, the different store information presentation unit 102 transmits, to the output apparatus provided in a different store other than store B, different store information relating to merchandise of tastes in accordance with the gender, age and the like of the customers visiting store B, determined by the different store information determination unit 110. The first output apparatus 22a provided in store A outputs different store information regarding merchandise of tastes in accordance with the gender, age and the like of customers visiting store B. Additionally, the second output apparatus 22b provided in store B outputs different store information regarding merchandise of tastes in accordance with the gender, age and the like of customers visiting store A.

By doing so, it is possible to output different store information regarding merchandise based on the tastes of the visiting customers. As a result thereof, it is possible to better stimulate economic activity.

### Third Exemplary Embodiment

Next, a sales promotion system 1 including a sales promotion apparatus 10 according to a third exemplary embodiment of the present invention will be explained. The sales promotion system 1 according to the present exemplary embodiment, as shown in FIG. 10, includes a sales promotion apparatus 10, a first store apparatus 20a, a second store apparatus 20b, a first visiting customer information acquisition apparatus 21a, a second visiting customer information acquisition apparatus 21b, a first output apparatus 22a, and a second output apparatus 22b, as provided in the sales promotion system 1 according to the first exemplary embodiment, and in addition thereto, further includes a settlement substitution apparatus 30.

The sales promotion apparatus 10 is identical to the sales promotion apparatus 10 according to the first exemplary embodiment.

In addition to the functions of the first store apparatus 20a according to the first exemplary embodiment, the first store apparatus 20a further has a function of settling substitution using the settlement substitution apparatus 30.

In addition to the functions of the second store apparatus 20b according to the first exemplary embodiment, the second store apparatus 20b further has a function of settling substitution using the settlement substitution apparatus 30.

The settlement substitution apparatus 30 performs the processing for settlement substitution made by the first store apparatus 20a and the second store apparatus 20b.

Next, the structure of the first store apparatus 20a provided in store A according to the present exemplary embodiment will be explained.

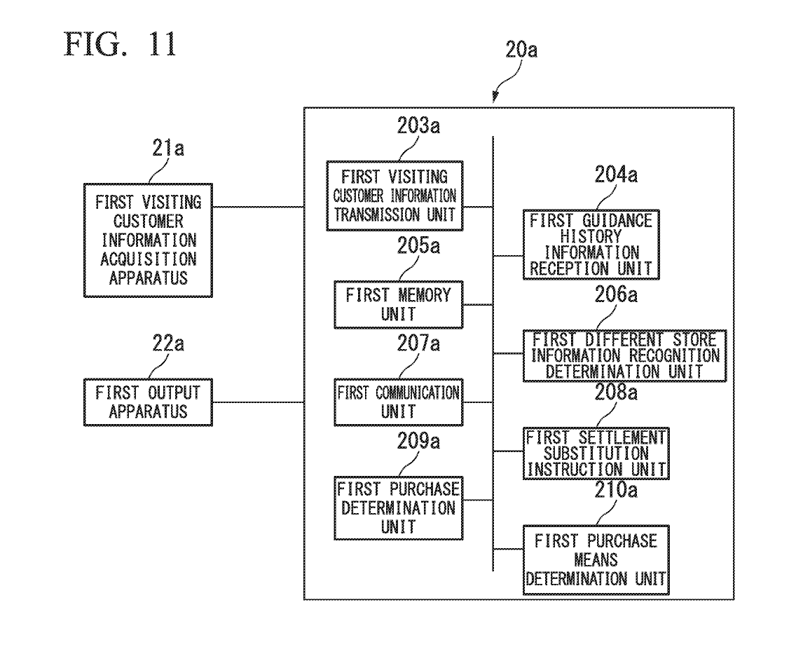

The first store apparatus 20a according to the present exemplary embodiment, as shown in FIG. 11, includes a first visiting customer information acquisition apparatus 21a, a first output apparatus 22a, a first visiting customer information transmission unit 203a, a first guidance history information reception unit 204a, a first memory unit 205a, a first different store information recognition determination unit 206a, and a first communication unit 207a, as in the first exemplary embodiment, and in addition thereto, further includes a first settlement substitution instruction unit 208a, a first purchase determination unit 209a, and a first purchase means determination unit 210a.

The first purchase determination unit 209a determines whether or not a visiting customer wishes to purchase merchandise being sold by a different store other than store A. Upon determining that the visiting customer wishes to purchase merchandise being sold by the different store other than store A, the first purchase determination unit 209a transmits, to the first purchase means determination unit 210a, a purchase signal indicating that a purchase is to be made.

The first purchase means determination unit 210a determines, on the basis of the purchase signal, whether the purchase means will be by settlement substitution or by introduction to the different store. If it is determined that the purchase means is to be introduction to the different store, then the first purchase means determination unit 210a outputs the location of the different store to the first output apparatus 22a. If it is determined that the purchase means is to be by settlement substitution, then the first purchase means determination unit 210a acquires required settlement information, required for using the settlement substitution, which is inputted by an input operation, and outputs the acquired required settlement information to the first settlement substitution instruction unit 208a.

The first settlement substitution instruction unit 208a transmits a settlement instruction signal instructing the settlement substitution apparatus 30 to process the settlement. It is to be noted that the settlement instruction signal includes information such as the name of the merchandise, the number of items of the merchandise, and the price of the merchandise. The first settlement substitution instruction unit 208a is a functional unit that performs settlement substitution when a customer visiting store A wishes to purchase merchandise being sold at a different store other than store A, and is a functional unit that instructs the settlement substitution apparatus 30 to process the settlement.

Upon acquiring the settlement instruction signal from the first settlement substitution instruction unit 208a, the settlement substitution apparatus 30 performs a settlement process based on the acquired settlement instruction signal. For example, the settlement substitution apparatus 30 may transmit the information such as the name of the merchandise, the number of items of the merchandise, and the price of the merchandise included in the settlement instruction signal to the second store apparatus 20b.

Next, the structure of the second store apparatus 20b provided in store B according to the present exemplary embodiment will be explained.

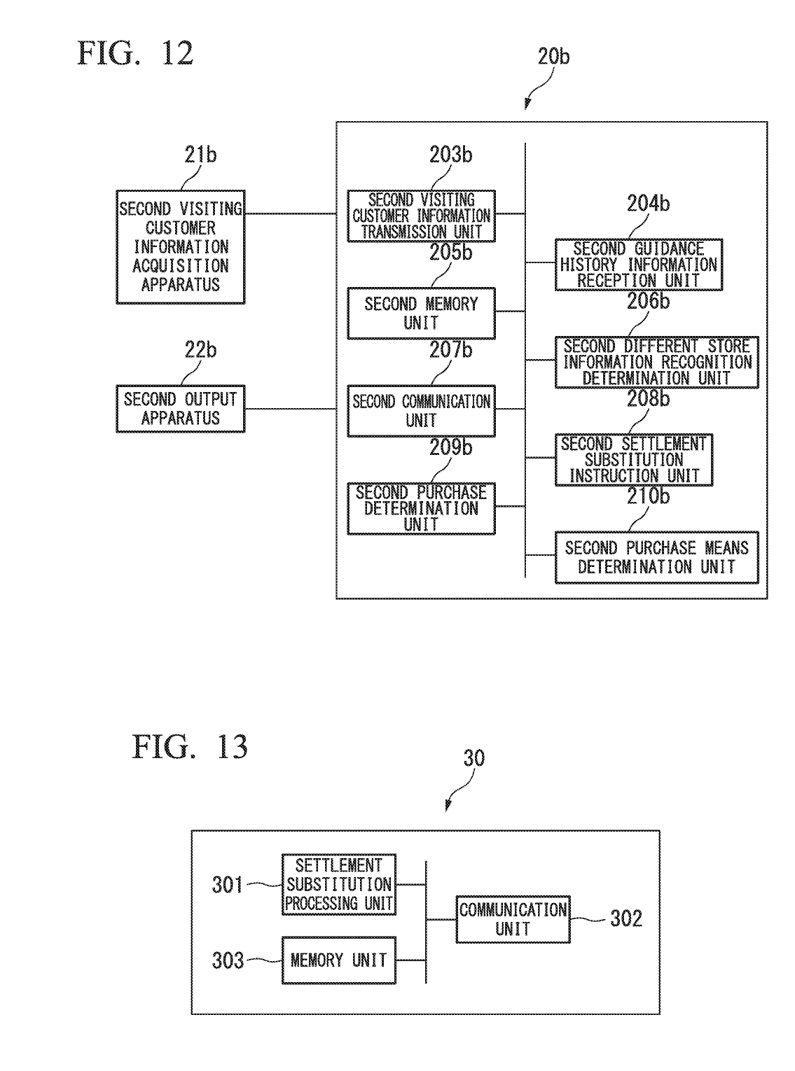

The second store apparatus 20b according to the present exemplary embodiment, as shown in FIG. 12, includes a second visiting customer information acquisition apparatus 21b, a second output apparatus 22b, a second visiting customer information transmission unit 203b, a second guidance history information reception unit 204b, a second memory unit 205b, a second different store information recognition determination unit 206b, and a second communication unit 207b, as in the first exemplary embodiment, and in addition thereto, further includes a second settlement substitution instruction unit 208b, a second purchase determination unit 209b and a second purchase means determination unit 210b.

The second purchase determination unit 209b determines whether or not a visiting customer wishes to purchase merchandise being sold by a different store other than store B. Upon determining that the visiting customer wishes to purchase merchandise being sold by the different store other than store B, the second purchase determination unit 209b transmits, to the second purchase means determination unit 210b, a purchase signal indicating that a purchase is to be made.

The second purchase means determination unit 210b determines, on the basis of the purchase signal, whether the purchase means will be by settlement substitution or by introduction to the different store. If it is determined that the purchase means is to be introduction to the different store, then the second purchase means determination unit 210b outputs the location of the different store to the second output apparatus 22b. If it is determined that the purchase means is to be by settlement substitution, then the second purchase means determination unit 210b acquires required settlement information, required for using the settlement substitution, which is inputted by an input operation, and outputs the acquired required settlement information to the second settlement substitution instruction unit 208b.

The second settlement substitution instruction unit 208b transmits a settlement instruction signal instructing the settlement substitution apparatus 30 to process the settlement. The second settlement substitution instruction unit 208b is a functional unit that performs settlement substitution when a customer visiting store B wishes to purchase merchandise being sold at a different store other than store B, and is a functional unit that instructs the settlement substitution apparatus 30 to process the settlement.

Upon acquiring the settlement instruction signal from the second settlement substitution instruction unit 208b, the settlement substitution apparatus 30 performs a settlement process based on the acquired settlement instruction signal. For example, the settlement substitution apparatus 30 may transmit information such as the name of the merchandise, the number of items of the merchandise, and the price of the merchandise included in the settlement instruction signal to the first store apparatus 20a.

Next, the structure of the settlement substitution apparatus 30 according to the present exemplary embodiment will be explained.

The settlement substitution apparatus 30 according to the present exemplary embodiment includes a settlement substitution processing unit 301, a communication unit 302, and a memory unit 303, as shown in FIG. 13.

The settlement substitution processing unit 301 processes settlement substitution that is used in the sales promotion system 1 according to the present exemplary embodiment.

The communication unit 302 transmits and receives, with respect to the first store apparatus 20a and the second store apparatus 20b, information required for using the settlement substitution.

The memory unit 303 stores various types of information required for the processing to be performed by the settlement substitution apparatus 30.

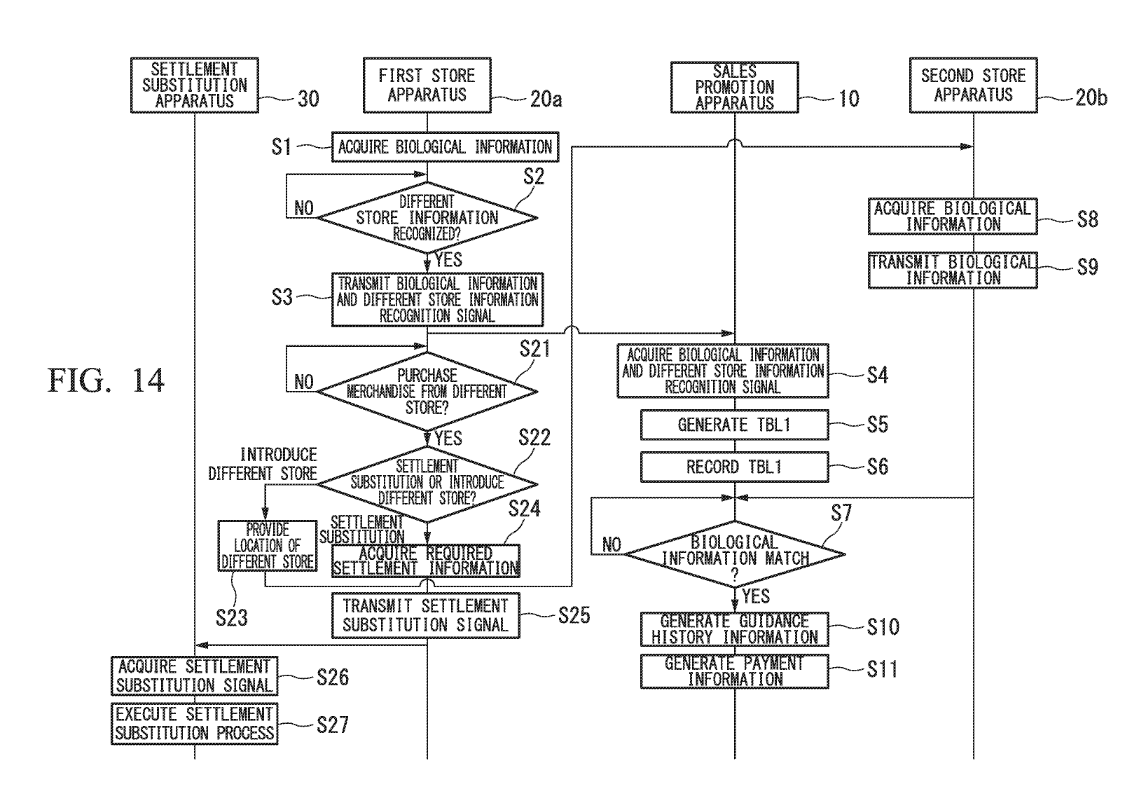

Next, the procedural flow of the sales promotion system 1 according to the present exemplary embodiment shown in FIG. 14 will be explained.

It is to be noted that it is assumed that store A and store B have already been registered in the sales promotion system 1, the first store apparatus 20a provided in store A outputs store information regarding store B, and the second store apparatus 20b provided in store B outputs store information regarding store A. The procedure performed by the sales promotion system 1 when a customer visiting store A purchases merchandise sold by store B and uses a settlement substitution will be explained.

It is to be noted that the procedure from step S21 to step S27, which differs from the procedure in the sales promotion system 1 according to the first exemplary embodiment, will be explained here.

The first visiting customer information transmission unit 203a transmits, to the sales promotion apparatus 10, the biological information of a visiting customer and a different store information recognition signal as a result of the processing in step S3.

Then, the first purchase determination unit 209a determines whether or not the visiting customer wishes to purchase merchandise being sold by the different store other than store A (step S21). For example, the first purchase determination unit 209a may detect an input operation associated with the purchase of merchandise sold by the different store other than store A, outputted by the first output apparatus 22a, and determines whether or not the visiting customer is to purchase the merchandise based on the detection results. Additionally, for example, the first purchase determination unit 209a may detect an input operation wherein an employee at store A orally asks a visiting customer whether or not merchandise being sold by the different store other than store A is to be purchased, and inputs the result thereof, and determines whether or not the visiting customer wishes to purchase the merchandise based on the detection results.

If the first purchase determination unit 209a determines that the visiting customer does not wish to purchase the merchandise being sold by the different store other than store A (step S21, NO), then the procedure returns to step S21.

Additionally, if the first purchase determination unit 209a determines that the visiting customer wishes to purchase the merchandise being sold by the different store other than store A (step S21, YES), then it transmits, to the first purchase means determination unit 210a, a purchase signal indicating that a purchase is to be made. When the purchase signal is inputted from the first purchase determination unit 209a, the first purchase means determination unit 210a determines whether the purchase means is to be by settlement substitution or by introduction of the different store (step S22). For example, if the first purchase means determination unit 210a detects an input operation indicating introduction of the different store, then it determines that the purchase means is introduction of the different store (step S22, “Introduction of different store”). Additionally, if the first purchase means determination unit 210a detects an input operation indicating the use of a settlement substitution, then it determines that the purchase means is by settlement substitution (step S22, “Settlement substitution”).

If the first purchase means determination unit 210a determines that the purchase means is introduction of a different store (step S22, “Introduce different store”), it causes the first output apparatus 22a to output the location of the different store (step S23). Then, the procedure continues with the processing at the different store in step S8.

Additionally, if the first purchase means determination unit 210a determines that the purchase means is to be by settlement substitution (step S22, “Settlement substitution”), it acquires the required settlement information, which is required for settlement substitution, such as the name of the merchandise, the number of items of merchandise, and the price of the merchandise, inputted by an input operation (step S24). The first purchase means determination unit 210a outputs, to the first settlement substitution instruction unit 208a, the acquired required settlement information.

The first settlement substitution instruction unit 208a generates a settlement instruction signal indicating an instruction to use a settlement substitution based on the required settlement information acquired from the first purchase means determination unit 210a. The first settlement substitution instruction unit 208a transmits the generated settlement substitution instruction signal to the settlement substitution apparatus 30 (step S25).

The settlement substitution processing unit 301 acquires the settlement instruction signal from the first store apparatus 20a (step S26). The settlement substitution processing unit 301 performs processes associated with the settlement substitution on the basis of the acquired settlement instruction signal (step S27). For example, the settlement substitution processing unit 301 may transmit, to the second store apparatus 20b, the information such as the name of the merchandise, the number of items of merchandise, and the price of the merchandise, included in the settlement instruction signal. It is to be noted that the processes associated with the settlement substitution performed by the settlement substitution processing unit 301 are actually more complicated, but they can be performed using related conventional art.

Fees are exchanged between store A in which the first store apparatus 20a is provided and store B in which the second store apparatus 20b is provided, based on the processes performed by the settlement substitution processing unit 301.

The sales promotion system 1 according to the third exemplary embodiment of the present invention has been explained above. In the above-described sales promotion apparatus 10, the first visiting customer information acquisition unit 101 acquires biological information of customers visiting the one store from the first visiting customer information acquisition apparatus 21a provided in the one store. The different store information presentation unit 102 outputs information regarding the different store other than the one store to the first output apparatus 22a (output apparatus) provided in the one store. The second visiting customer information acquisition unit 103 acquires biological information of customers visiting the different store from the second visiting customer information acquisition apparatus 21b provided in the different store. The visiting customer match determination unit 104 determines whether or not there is a match between the biological information acquired by the first visiting customer information acquisition unit 101 and the biological information acquired by the second visiting customer information acquisition unit 103.

By doing so, it is possible to guide various diverse visiting customers to different stores. Additionally, various diverse visiting customers can be guided to different stores without the need to register membership. As a result, economic activity can be stimulated.

Additionally, the first purchase determination unit 209a determines whether or not a visiting customer wishes to purchase merchandise being sold by the different store other than store A. The first purchase means determination unit 210a determine whether the purchase means is to be by settlement substitution or by introduction of the different store. The first settlement substitution instruction unit 208a generates a settlement instruction signal indicating an instruction to use the settlement substitution based on acquired required settlement information. The first settlement substitution instruction unit 208a transmits the generated settlement instruction signal to the settlement substitution apparatus 30. The settlement substitution processing unit 301 performs processes associated with the settlement substitution, based on the settlement instruction signal acquired from the first store apparatus 20a. Fees are exchanged between store A in which the first store apparatus 20a is provided and store B in which the second store apparatus 20b is provided, based on the processes performed by the settlement substitution processing unit 301.

By doing so, customers visiting store A can be guided to the location of different stores other than store A. Additionally, customers visiting store A can use settlement substitution to purchase merchandise being sold in different stores other than store A. As a result, economic activity can be further stimulated.

It is to be noted that in the exemplary embodiments of the present invention, as long as information can be appropriately transmitted and received, the functional units provided in the sales promotion apparatus 10 may be partially or completely provided in the first store apparatus 20a. Additionally, the functional units provided in the sales promotion apparatus 10 may be partially or completely provided in the second store apparatus 20b. Additionally, the functional units provided in the sales promotion apparatus 10 may be partially or completely distributed between the first store apparatus 20a and the second store apparatus 20b.

Additionally, the visiting customer match determination unit 104 may determine whether or not there is a match in terminal output information from terminals possessed by visiting customers, instead of using biological information. Additionally, the visiting customer match determination unit 104 may determine whether or not there is a match in image information of visiting customers, instead of using biological information.

It is to be noted that the memory unit 106, the first memory unit 205a, and the second memory unit 205b in the present invention may respectively be provided anywhere within a range in which appropriate transmission and reception of information can be achieved. Additionally, the memory unit 106, the first memory unit 205a, and the second memory unit 205b may each include multiple units and the data may be stored in distributed form, within a range in which appropriate transmission and reception of information can be achieved.

It is to be noted that in the procedural flow in the exemplary embodiments of the present invention, the sequence of the steps may be switched, within a range in which an appropriate procedure can be performed.

It is to be noted that while exemplary embodiments of the present invention have been explained, the above-described sales promotion apparatus 10, the first store apparatus 20a, and the second store apparatus 20b each have a computer system in the interior thereof. Additionally, the steps in the above-described procedures are stored, in the form of programs, in computer-readable memory units, and the above-described procedures are performed by a computer reading out and executing these programs. In this case, computer-readable memory units refer to magnetic disks, magneto-optic disks, CD-ROMs (Compact Disc-Read Only Memory), DVD-ROMs (Digital Versatile Disc-Read Only Memory), semiconductor memory, and the like. Additionally, the computer programs could be delivered to a computer over a communication channel, and a computer receiving the delivery could then execute the program.

Additionally, the above-described programs may be for performing a portion of the aforementioned functions. Furthermore, the aforementioned functions may be provided in the form of a so-called difference file (difference program), which is implemented in combination with a program that is already recorded in a computer system.

While multiple embodiments of the present invention have been explained, these embodiments are merely exemplary, and should not be construed as limiting the scope of the invention. Additionally, various omissions, substitutions, and modification may be made within a range not departing from the gist of the invention.

The present application claims priority on the basis of Japanese Patent Application No. 2015-057770, filed on Mar. 20, 2015, the disclosure of which is incorporated herein by reference.

### INDUSTRIAL APPLICABILITY

The present invention may, for example, be applied to various types of stores. According to the present invention, it is possible to guide various diverse visiting customers to different stores.

### DESCRIPTION OF REFERENCE SIGNS

1 Sales promotion system
10 Sales promotion apparatus
20a First store apparatus
20b Second store apparatus
21a First visiting customer information acquisition apparatus
21b Second visiting customer information acquisition apparatus
22a First output apparatus
22b Second output apparatus
30 Settlement substitution apparatus
101 First visiting customer information acquisition unit
102 Different store information presentation unit
103 Second visiting customer information acquisition unit
104 Visiting customer match determination unit
105, 302 Communication unit
106, 303 Memory unit
107 Guidance history information generation unit
108 Payment information generation unit
203a First visiting customer information transmission unit
203b Second visiting customer information transmission unit
204a First guidance history information reception unit
204b Second guidance history information reception unit
205a First memory unit
205b Second memory unit
206a First different store information recognition determination unit
206b Second different store information recognition determination unit
207a First communication unit
207b Second communication unit
208a First settlement substitution instruction unit
208b Second settlement substitution instruction unit
209a First purchase determination unit
209b Second purchase determination unit
210a First purchase means determination unit
210b Second purchase means determination unit
301 Settlement substitution processing unit
A, B Store

1. A sales promotion apparatus comprising:
a first visiting customer information acquisition unit that acquires, from a first visiting customer information acquisition apparatus provided in one store, biological information of a customer visiting the one store;
a different store information presentation unit that outputs, to an output apparatus provided in the one store, information regarding a different store other than the one store;
a second visiting customer information acquisition unit that acquires, from a second visiting customer information acquisition apparatus provided in the different store, biological information of a customer visiting the different store; and
a visiting customer match determination unit that determines whether there is a match between the biological information acquired by the first visiting customer information acquisition unit and the biological information acquired by the second visiting customer information acquisition unit.

2. The sales promotion apparatus according to claim 1, comprising a guidance history information generation unit that generates information indicating a guidance history from the one store to the different store, when the visiting customer match determination unit determines that there is a match between the biological information acquired by the first visiting customer information acquisition unit and the biological information acquired by the second visiting customer information acquisition unit.

3. The sales promotion apparatus according to claim 2, comprising a payment information generation unit that generates payment information from the different store to the one store based on the information indicating the guidance history from the one store to the different store, generated by the guidance history information generation unit.

4. The sales promotion apparatus according to claim 1, wherein the visiting customer match determination unit determines whether there is a match between terminal output information of a terminal carried by a customer visiting the one store and terminal output information of a terminal carried by a customer visiting the different store, instead of the biological information.

5. The sales promotion apparatus according to claim 1, wherein the visiting customer match determination unit determines whether there is a match between image information of a customer visiting the one store and image information of a customer visiting the different store, instead of the biological information.

6. A sales promotion system comprising:
the sales promotion apparatus according to claim 1;
a visiting customer information acquisition apparatus that acquires biological information; and
an output apparatus that outputs information from the sales promotion apparatus, which outputs, to the output apparatus provided in the one store, information regarding the different store other than the one store.

7. A store system comprising:
a visiting customer information acquisition apparatus that acquires biological information;
an output apparatus that outputs information from a sales promotion apparatus, which outputs, to an output apparatus provided in one store, information regarding a different store other than the one store; and
a store apparatus that receives information indicating a guidance history from the sales promotion apparatus, which comprises a visiting customer information acquisition unit that acquires the biological information transmitted from the visiting customer information acquisition apparatus.

8. A store system comprising:
a visiting customer information acquisition apparatus that acquires biological information;
an output apparatus that outputs information from a sales promotion apparatus, which outputs, to an output apparatus provided in one store, information regarding a different store other than the one store; and
a store apparatus that determines whether or not a visiting customer has acquired the information regarding the different store outputted by the output apparatus, and that, upon determining that the visiting customer has acquired the information regarding the different store, outputs biological information of the visiting customer to the sales promotion apparatus, which comprises a first visiting customer information acquisition unit that acquires the biological information transmitted from the visiting customer information acquisition apparatus.

9. (canceled)

10. (canceled)
